(19) United States
(12) Patent Application Publication
(10) Pub. No.: US 2026/0299185 A1
(43) Pub. Date: Oct. 1, 2026

(54) ELECTRONIC DEVICE

(71) Applicant: InnoLux Corporation, Chu-Nan (TW)

(72) Inventors: Hui-Wen SU, Chu-Nan (TW); Wei-Tsung HSU, Chu-Nan (TW); Chi FANG, Chu-Nan (TW)

(21) Appl. No.: 19/549,957

(22) Filed: Feb. 25, 2026

(30) Foreign Application Priority Data
Mar. 25, 2025 (CN) 202510354928.8

(51) Int. Cl. F21V 8/00; G02B 5/02

(52) U.S. Cl. CPC G02B 6/0053; G02B 5/0231

(57) ABSTRACT

An electronic device includes a light adjustment element; and a light source providing element disposed below the light adjustment element and including a light guide plate; a light source adjacent to the light guide plate; a first prism structure disposed on the light guide plate and facing the light guide plate; a second prism structure disposed on the first prism structure and facing the light adjustment element; and a third prism structure disposed on the second prism structure and facing the light adjustment element. An extension direction of the first prism structure is perpendicular to an extension direction of the light source. An included angle between an extension direction of the second prism structure and the extension direction of the light source is 45 or 135 degrees. An extension direction of the third prism structure is not perpendicular to the extension direction of the second prism structure.

### CROSS-REFERENCE TO RELATED APPLICATIONS

This application claims the benefits of the Chinese Patent Application Serial Number 202510354928.8, filed on Mar. 25 2025, the subject matter of which is incorporated herein by reference.

### BACKGROUND

### Field of the Disclosure

The present disclosure relates to an electronic device and, more particularly, to the technology related to a light source providing element of an electronic device.

### Description of Related Art

Currently, to achieve thinness and high efficiency (e.g., low power consumption), a light source providing element of an electronic device is typically provided with multiple optical films along the light path. Some of the films have specially designed beam-splitting structures on the surfaces. For example, a large number of specially shaped beam-splitting structures may be placed on the lower optical film for beam splitting. These specially shaped beam-splitting structures may be, for example, numerous pyramid-shaped beam-splitting structures, hereinafter referred to as pyramid structures, and are used as an example. With such a design, the light from the light source, after entering the light guide plate, is first split by the lower pyramid-structured optical film, and then collected by the upper optical film (e.g., an optical film with a prism structure), so as to allow the light to be primarily distributed within the user's direct viewing angle, thereby achieving high light extraction efficiency. However, the pyramid structure design is more complex, resulting in higher production costs. Furthermore, the pyramid structure is prone to causing a yellow sun effect, such as noticeable chromatic aberration within the direct viewing angle range of the electronic device.

Therefore, there is a need for an improved electronic device to alleviate and/or obviate the above-mentioned problems.

### SUMMARY

The present disclosure provides an electronic device, which includes a light adjustment element; and a light source providing element disposed below the light adjustment element. The light source providing element includes: a light guide plate; a light source adjacent to the light guide plate; a first prism structure disposed on the light guide plate and facing the light guide plate; a second prism structure disposed on the first prism structure and facing the light adjustment element; and a third prism structure disposed on the second prism structure and facing the light adjustment element, wherein an extension direction of the first prism structure is perpendicular to an extension direction of the light source, an included angle between an extension direction of the second prism structure and the extension direction of the light source is 45 degrees or 135 degrees, and an extension direction of the third prism structure is not perpendicular to the extension direction of the second prism structure.

Other novel features of the disclosure will become more apparent from the following detailed description when taken in conjunction with the accompanying drawings.

### BRIEF DESCRIPTION OF DRAWINGS

FIG. 1A is a structural schematic diagram of the electronic device according to the first embodiment of the present disclosure;

FIG. 1B is a three-dimensional diagram of the electronic device according to the first embodiment of the present disclosure;

FIG. 1C shows the light pattern diagrams corresponding to the optical films of the light source providing element according to the first embodiment of the present disclosure;

FIG. 1D shows the light pattern diagrams corresponding to another aspect of the optical films of the light source providing element according to the first embodiment of the present disclosure;

FIG. 2 is a schematic diagram of the viewing angle and chromatic aberration value of the electronic device according to the first embodiment of the present disclosure;

FIG. 3A is a schematic diagram of the electronic device according to the second embodiment of the present disclosure;

FIG. 3B is a schematic diagram of the electronic device according to the third embodiment of the present disclosure,

FIG. 4A is a schematic structural diagram of the electronic device according to the fourth embodiment of the present disclosure;

FIG. 4B shows a three-dimensional exploded view of the electronic device according to the fourth embodiment of the present disclosure;

FIG. 4C shows the light pattern diagrams corresponding to the optical films of the light source providing element according to the fourth embodiment of the present disclosure; and

FIG. 5 is a schematic diagram of the electronic device according to the fifth embodiment of the present disclosure.

### DETAILED DESCRIPTION OF EMBODIMENT

Reference will now be made in detail to exemplary embodiments of the present application, examples of which are illustrated in the accompanying drawings. Wherever possible, the same reference numerals are used in the drawings and description to refer to the same or like parts.

Throughout the specification and the appended claims, certain terms may be used to refer to specific components. Those skilled in the art will understand that electronic device manufacturers may refer to the same components by different names. The present application does not intend to distinguish between components that have the same function but have different names. In the following description and claims, words such as “containing” and “comprising” are open-ended words, and should be interpreted as meaning “including but not limited to”.

The terms, such as “about”, “substantially”, or “approximately” are generally interpreted as within 10% of a given value or range, or as within 5%, 3%, 2%, 1% or 0.5% of a given value or range.

In the specification and claims, unless otherwise specified, ordinal numbers, such as “first” and “second”, used herein are intended to distinguish components rather than disclose explicitly or implicitly that names of the components bear the wording of the ordinal numbers. The ordinal numbers do not imply what order a component and another component are in terms of space, time or steps of a manufacturing method. Thus, what is referred to as a “first component” in the specification may be referred to as a “second component” in the claims.

In the present application, the terms “the given range is from the first numerical value to the second numerical value” and “the given range falls within the range from the first numerical value to the second numerical value” mean that the given range includes the first numerical value, the second numerical value, and other numerical values therebetween.

The electronic device of the present disclosure may include a light-emitting device, a display device, automated equipment, a clamping device, a computing device, mechanical equipment, drug dispensing equipment, an exposure device, a printing device, a three-dimensional printing device, an automotive device, an image-capturing device, an assembly device, a backlight device, an antenna device, a tiled device, a touch electronic device, a curved electronic device, or free-shape electronic device, but not limited thereto. The display device may include, for example, liquid crystal, light-emitting diode, fluorescence, phosphorescence, other suitable display media, or a combination thereof, but not limited thereto. The display device may be a non-self-emissive display device or a self-emissive display device. The antenna device may be a liquid crystal type antenna device or a non-liquid crystal type antenna device. The sensing device may sense capacitive, light, heat, or ultrasonic waves, but not limited thereto. The tiled device may include, for example, a display tiled device or an antenna tiled device, but not limited thereto. It should be noted that the electronic device may be any of the aforementioned arrangements and combinations, but not limited thereto. Furthermore, the electronic device may be bendable or flexible. The shape of the electronic device may be rectangular, circular, polygonal, with curved edges, or other suitable shapes. The electronic device may have a peripheral system such as a drive system, a control system, a light source system, and a shelving system to support the display device, antenna device, or tiled device. For ease of explanation, in the following description the electronic device is exemplified by a display device.

It is noted that the following are exemplary embodiments of the present application, but the present disclosure is not limited thereto, while a feature of some embodiments can be applied to other embodiments through suitable modification, substitution, combination, or separation. In addition, the present disclosure can be combined with other known structures to form further embodiments.

Unless otherwise defined, all terms (including technical and scientific terms) used herein have the same meaning as commonly understood by those skilled in the art related to the present application. It can be understood that these terms, such as those defined in commonly used dictionaries, should be interpreted as having meaning consistent with the relevant technology and the background or context of the present disclosure, and should not be interpreted in an idealized or excessively formal way, unless there is a special definition in the embodiment of the present application.

In addition, the term “adjacent” in the specification and claims is used to describe mutual proximity, and does not necessarily mean mutual contact.

In addition, descriptions such as “when” or “while” in the present application represent aspects such as “now, before or after”, and are not limited to situations that occur at the same time. In the present application, similar descriptions such as “disposed on” refer to the corresponding positional relationship between the two components, and do not limit whether there is contact between the two components, unless otherwise specified. Furthermore, when the present disclosure provides multiple functions, if the word “or” is used between the functions, it means that the functions may exist independently, but it does not exclude that multiple functions may exist simultaneously.

In the present disclosure, any angle mentioned may have a tolerance of plus or minus 10 degrees.

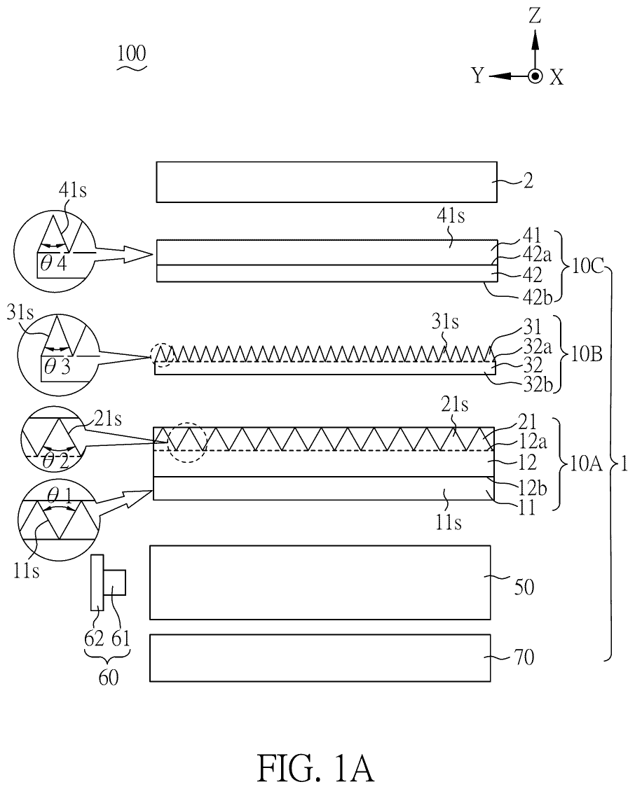

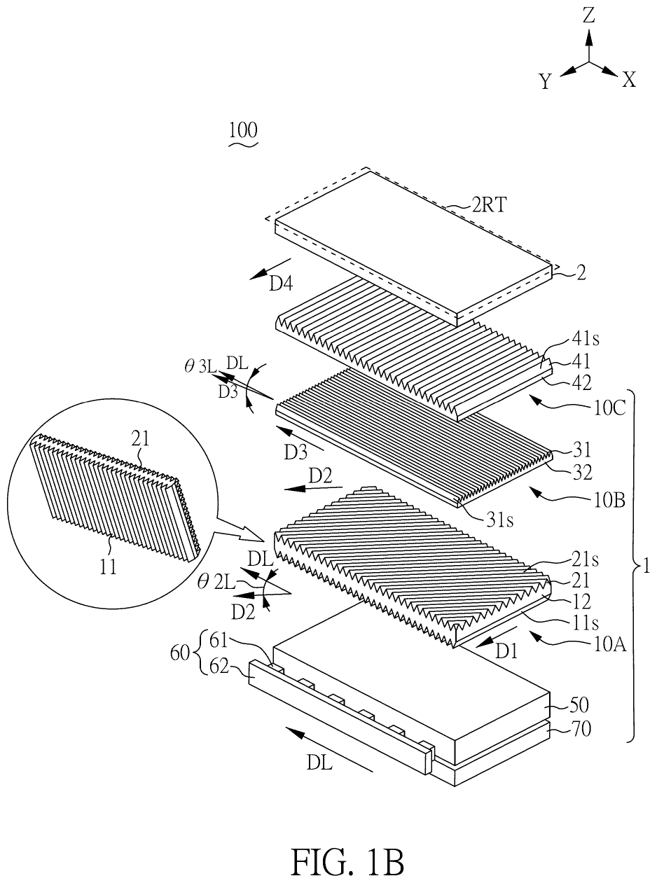

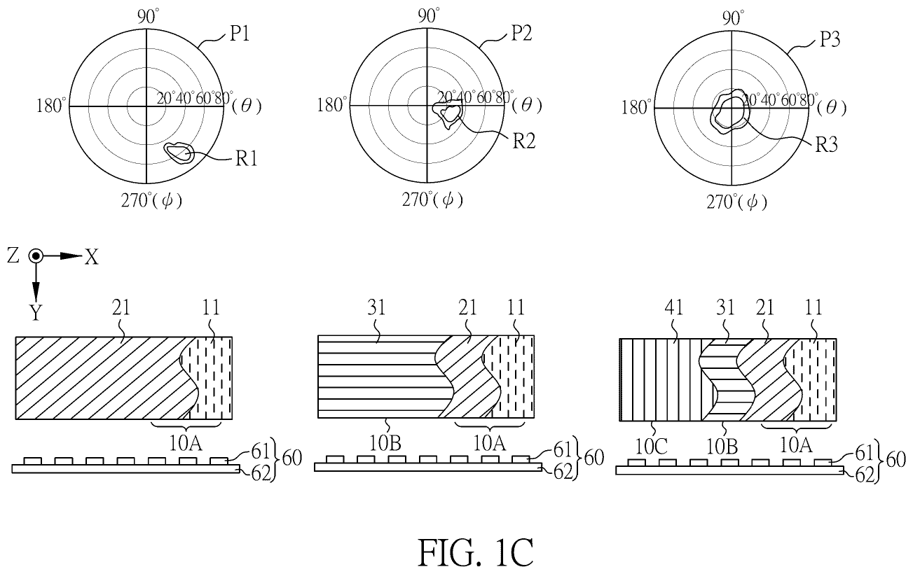

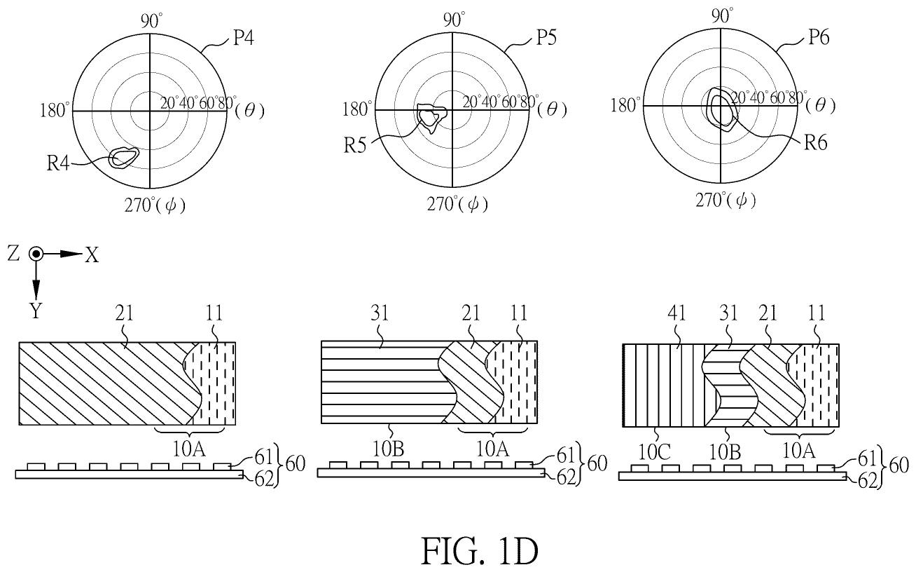

Furthermore, for clarity, the directions in the figures will be defined as X, Y and Z directions below. When the electronic device 100 is a display device, the Z direction is the display direction of the electronic device 100 and may correspond to the front viewing angle of the electronic device 100. In some embodiments, when the device is of arbitrary shape, a minimum virtual rectangle that encloses the shape of the device may be defined, wherein the side with the minimum side length of the minimum virtual rectangle is used as a reference side, and the direction parallel to the extension direction of the reference side is the first direction (e.g., the Y direction). When the minimum virtual rectangle is a square, the side with the minimum side length may be any side. Taking FIG. 1B of the present disclosure as an example, a minimum virtual rectangle 2RT that encloses the light adjustment element 2 may be defined, wherein the direction parallel to the minimum side length of the minimum virtual rectangle 2RT is the Y direction, the direction perpendicular to the minimum side length of the minimum virtual rectangle 2RT is the X direction, and the directions perpendicular to both the X and Y directions are the Z directions.

Please refer to FIG. 1A and FIG. 1B, wherein FIG. 1A is a structural schematic diagram of the electronic device 100 according to the first embodiment of the present disclosure that presents an exploded view from a single perspective, and FIG. 1B is a three-dimensional diagram of the electronic device 100 according to the first embodiment of the present disclosure that presents a three-dimensional exploded view. As shown in FIG. 1A, the electronic device 100 includes a light source providing element 1 and a light adjustment element 2, wherein the light adjustment element 2 is used to adjust various light types such as wavelength, intensity, brightness or phase, but it is not limited thereto. In some embodiments, the light adjustment element may be a filter layer, a quantum dot (QD) layer, or a liquid crystal layer, but it is not limited thereto. In some embodiments, the light adjustment element 2 may be, for example, a display panel composed of various types in a display device. In the Z direction, the light source providing element 1 is disposed below the light adjustment element 2. The light source providing element 1 may include direct-lit, edge-lit, or array-lit types, but it is not limited thereto. In some embodiments, the light source providing element 1 may at least include a first prism structure 11, a second prism structure 21, a third prism structure 31, a light guide plate 50 and a light source 60, wherein the light guide plate 50 may be selectively provided or not provided according to design requirements. In one embodiment, the light source providing element 1 may further include a fourth prism structure 41 and a reflective sheet 70, wherein the reflective sheet 70 may be selectively provided or not provided according to design requirements. In the Z direction, the light guide plate 50 may be disposed on the reflective sheet 70, the first prism structure 11 may be disposed on the light guide plate 50, the second prism structure 21 may be disposed on the first prism structure 11, the third prism structure 31 may be disposed on the second prism structure 21, the fourth prism structure 41 may be disposed on the third prism structure 31, and the light source 60 is adjacent to the light guide plate 50. The first prism structure 11 faces the light guide plate 50, while the second prism structure 21, the third prism structure 31 and the fourth prism structure 41 face the light adjustment element 2. In one embodiment, the light source 60 may include a plurality of light emitting units 61 and a substrate 62, and the light emitting units 61 are disposed on the substrate 62, but it is not limited thereto.

The materials of the first prism structure 11 to the fourth prism structure 41 and the light guide plate 50 may be various known materials, while it is not limited thereto. In one embodiment, the type of the light emitting unit 61 of the light source 60 may include a light emitting diode, such as an organic light emitting diode (OLED), a sub-millimeter light emitting diode (mini LED), a micro light emitting diode (micro LED), or a quantum dot light emitting diode (QLED, QDLED), fluorescence, phosphorescence or other suitable materials, or a combination thereof, while it is not limited thereto. In one embodiment, the material of the reflective sheet 70 is not particularly limited, and may include, but is not limited to, metal, white ink, other reflective materials, or a combination thereof. The metal may include gold, silver, copper, aluminum, or a combination thereof, but it is not limited thereto. The white ink may include white polyimide, resin, or a combination thereof, while it is not limited thereto. Furthermore, the reflective sheet 70 may include a single-layer or multi-layer film reflective sheet.

One of the features of the present disclosure is the configuration of the prism structures (11, 21, 31, 41). As shown in FIG. 1B, the light source 60 may have a light source extension direction DL parallel to the X direction, wherein the plurality of light emitting units 61 of the light source 60 are arranged along the light source extension direction DL. The first prism structure 11 has a first extension direction D1 perpendicular to the light source extension direction DL. For example, the first prism structure 11 may include a plurality of first strip structures 11s, each extending along the first extension direction D1. The second prism structure 21 has a second extension direction D2. For example, the second prism structure 21 may include a plurality of second strip structures 21s, each extending along the second extension direction D2. The second extension direction D2 and the light source extension direction DL have an included angle θ2L, which is 45 degrees or 135 degrees and may have an error value of ±10 degrees. The third prism structure 31 has a third extension direction D3. For example, the third prism structure 31 may include a plurality of third strip structures 31s, each extending along the third extension direction D3. The third extension direction D3 is not perpendicular to the second extension direction D2.

Furthermore, in one embodiment, the fourth prism structure 41 may have a fourth extension direction D4. For example, the fourth prism structure 41 may include a plurality of fourth strip structures 41s, each extending along the fourth extension direction D4. The fourth extension direction D4 may be perpendicular to the third extension direction D3. In one embodiment, the third extension direction D3 may be perpendicular to or parallel to the light source extension direction DL; for example, FIG. 1B shows a configuration that the third extension direction D3 is parallel to the light source extension direction DL. In other embodiments, the third extension direction D3 may also have an included angle θ3L with the light source extension direction DL, for example, between 0 and 45 degrees or between 135 and 180 degrees (0°≤θ3L≤45°, or 135°≤θ3L≤180°), or the third extension direction D3 may also have an included angle θ3L with the light source extension direction DL, between 45 and 135 degrees (45°≤θ3L≤135°), while it is not limited thereto. It should be noted that in the above cases, the third extension direction D3 still needs to be non-perpendicular to the second extension direction D2, and needs to be perpendicular to the fourth extension direction D4 (that is, the fourth extension direction D4 will be adjusted according to the direction of the third extension direction D3 to achieve the condition that the two are perpendicular).

As shown in FIG. 1A and FIG. 1B, in one embodiment, the light source providing element 1 may include a substrate 12. In the Z direction, a first prism structure 11 and a second prism structure 21 may be respectively disposed on opposite sides of the substrate 12. For example, the substrate 12 has a first side 12a and a second side 12b opposite to each other. The second side 12b is adjacent to the light guide plate 50. The first prism structure 11 may be disposed on the second side 12b, and the second prism structure 21 may be disposed on the first side 12a. In this way, the first prism structure 11, the substrate 12 and the second prism structure 21 can form an optical film 10A. In addition, in one embodiment, the light source providing element 1 may include a substrate 32, and in the Z direction, a third prism structure 31 may be disposed on one side of the substrate 32. For example, the substrate 32 has a first side 32a and a second side 32b opposite to each other. The second side 32b is adjacent to the second prism structure 21, and the third prism structure 31 may be disposed on the first side 32a, thereby forming an optical film 10B with the third prism structure 31 and the substrate 32. Similarly, in one embodiment, the light source providing element 1 may further include a substrate 42, and in the Z direction, a fourth prism structure 41 may be disposed on one side of the substrate 42. For example, the substrate 42 may have a first side 42a and a second side 42b opposite to each other, the first side 42b being away from the light adjustment element 2, and the fourth prism structure 41 being disposed on the first side 42a, thereby forming an optical film 10C with the fourth prism structure 41 and the substrate 42.

Next, the detailed parameters of the prism structure will be described. In one embodiment, the first prism structure 11 may have a first refractive index, which may be between 1.5 and 1.55 (greater than or equal to 1.5 and less than or equal to 1.55), while it is not limited thereto. In one embodiment, the second prism structure 21 may have a second refractive index, which may be between 1.5 and 1.55 (greater than or equal to 1.5 and less than or equal to 1.55), while it is not limited thereto. In one embodiment, the third prism structure 31 may have a third refractive index, which may be between 1.5 and 1.69 (greater than or equal to 1.5 and less than or equal to 1.69), while it is not limited thereto. In one embodiment, the fourth prism structure 41 may have a fourth refractive index, which may be between 1.5 and 1.69 (greater than or equal to 1.5 and less than or equal to 1.69), while it is not limited thereto.

Furthermore, as shown in FIG. 1A, in one embodiment, the first prism structure 11 may have a first vertex angle θ1, which may be between 60 degrees and 120 degrees (60°≤θ1≤120°), while it is not limited thereto. In one embodiment, the second prism structure 21 may have a second vertex angle θ2, which may be between 60 degrees and 120 degrees (60°≤θ2 ≤120°), while it is not limited thereto. In one embodiment, the third prism structure 31 may have a third vertex angle θ3, which may be between 60 degrees and 120 degrees (60°≤θ3 ≤120°), while it is not limited thereto. In one embodiment, the fourth prism structure 41 may have a fourth vertex angle θ4, which may be between 60 degrees and 120 degrees (60°≤θ4≤120°), while it is not limited thereto. By setting the above parameters, the light packet may be concentrated at the position corresponding to the positive viewing angle, thereby improving the light extraction efficiency of the electronic device 100.

Furthermore, by adjusting the extension direction of the first prism structure 11 to the fourth prism structure 41, the light extraction efficiency of the electronic device 100 may be improved. FIG. 1C shows the light pattern diagrams P1 to P3 corresponding to the optical films 10A to 10C of the light source providing element 1 according to the first embodiment of the present disclosure, and please refer to FIG. 1A and FIG. 1B as a reference. In FIG. 1C, from left to right, the light source providing element 1 is presented to have the optical film 10A only, the optical films 10A and 10B at the same time, and the optical films 10A, 10B and 10C at the same time. Furthermore, the light pattern diagrams P1 to P3 may have inclination angles (θ) from 0 degrees to 80 degrees and azimuth angles (ψ) from 0 degrees to 360 degrees. The inclination angle may be defined as the angle between the positive viewing angle (e.g., the Z direction) corresponding to the display device 100. For example, an inclination angle of 0 degrees indicates that it is parallel to the positive viewing angle (Z), and the larger the inclination angle, the larger the included angle between it and the positive viewing angle. In addition, the azimuth angle may be defined as the angle on the XY plane, wherein the light provided by the light source 60 is directed toward a position with an azimuth angle of 270 degrees, but it is not limited thereto.

As shown in FIG. 1C, the light provided by the light source 60 may enter the optical film 10A after passing through the light guide plate 50. In one embodiment, when the light source providing element 1 only has the optical film 10A, that is, only has a first prism structure 11 facing the light guide plate 50 and extending along the first extension direction D1 and a second prism structure 21 facing the light adjustment element 2 and extending along the second extension direction D2, the optical film 10A may split the light so that the light packet is approximately distributed in an area R1 with an azimuth angle of 270 degrees to 0 degrees and an inclination angle far from 0 degrees (for example, about 40 degrees to 80 degrees). It may be seen that the second prism structure 21, having the second extension direction D2, may provide a beam splitting effect similar to a pyramid structure. Next, when the light source providing element 1 has the optical films 10A and 10B, that is, when it also has a third prism structure 31 facing the light adjustment element 2 and extending along the third extension direction D3, the optical film 10A may split the light, and the optical film 10B may then collect the light. At this moment, on the corresponding light pattern diagram P2, the light packet is roughly distributed in the area R2 where the azimuth angle is close to 0 degrees and the inclination angle is close to 0 degrees (for example, about 20 degrees to 40 degrees). Next, when the light source providing element 1 simultaneously includes the optical films 10A to 10C, that is, when it also includes a fourth prism structure 41 facing the light adjustment element 2 and extending along the fourth extension direction D4, the optical film 10A may split the light, the optical film 10B may then perform a first light collection, and the optical film 10C may then perform a second light collection. At this moment, on the corresponding light pattern diagram P3, the light packet is roughly distributed in the center of the light pattern diagram P3 and the surrounding area R3. The corresponding inclination angle and azimuth angle may substantially correspond to the orthographic angle (e.g., concentrated at the center of the light pattern diagram P3). Thus, after the light passes through the specially designed optical films 10A to 10C, the light packet may be concentrated at the position corresponding to the orthographic angle, thereby improving the light extraction efficiency of the electronic device 100, while it is not limited thereto. Alternatively, the present disclosure does not require the use of a complicated pyramid structure, thus reducing production costs.

FIG. 1D shows the light pattern diagrams P4 to P6 corresponding to another aspect of the optical films 10A to 10C of the light source providing element 1 according to the first embodiment of the present disclosure, and please refer to FIG. 1A to FIG. 1C as a reference. The structure of the light source providing element 1 in FIG. 1D is generally similar to the light source providing element 1 in FIG. 1C, except that the second extension direction D2 of the second prism structure 21 in FIG. 1D and the second extension direction D2 of the second prism structure 21 in FIG. 1C are different. For example, the included angle between the second extension direction D2 in FIG. 1C and the light source extension direction DL is 45 degrees, while the included angle between the second extension direction D2 in FIG. 1D and the light source extension direction DL is 135 degrees. The features of FIG. 1D generally may be applicable to the description of FIG. 1C, and thus the following description will mainly focus on the differences.

As shown in FIG. 1D, in one embodiment, when the light source providing element 1 only has an optical film 10A, the optical film 10A may perform unilateral light splitting on the light passing through the light guide plate 50. For example, in the corresponding light pattern diagram P4, the light packets may be substantially distributed in the area R4 with an azimuth angle of 180 degrees to 270 degrees and an inclination angle far away from 0 degrees (for example, about 40 degrees to 80 degrees), while it is not limited thereto. Next, when the light source providing element 1 is equipped with the optical films 10A and 10B, the optical film 10A may split the light passing through the light guide plate 50, and the optical film 10B may then collect the light. For example, in the corresponding light pattern diagram P5, the light packet is substantially distributed in the range R5 with an inclination angle closer to 0 degrees (for example, about 20 degrees to 40 degrees) and an azimuth angle close to 180 degrees, while it is not limited thereto. Next, in one embodiment, when the light source providing element 1 is equipped with the optical films 10A to 10C, the optical film 10A may split the light, the optical film 10B may then collect the light for the first time, and the optical film 10C may then collect the light for the second time. For example, in the corresponding light pattern diagram P6, the light packets are substantially distributed in the center and the area R6 around the center of the light pattern diagram P6, that is, the light packets may be concentrated at the position corresponding to the front viewing angle.

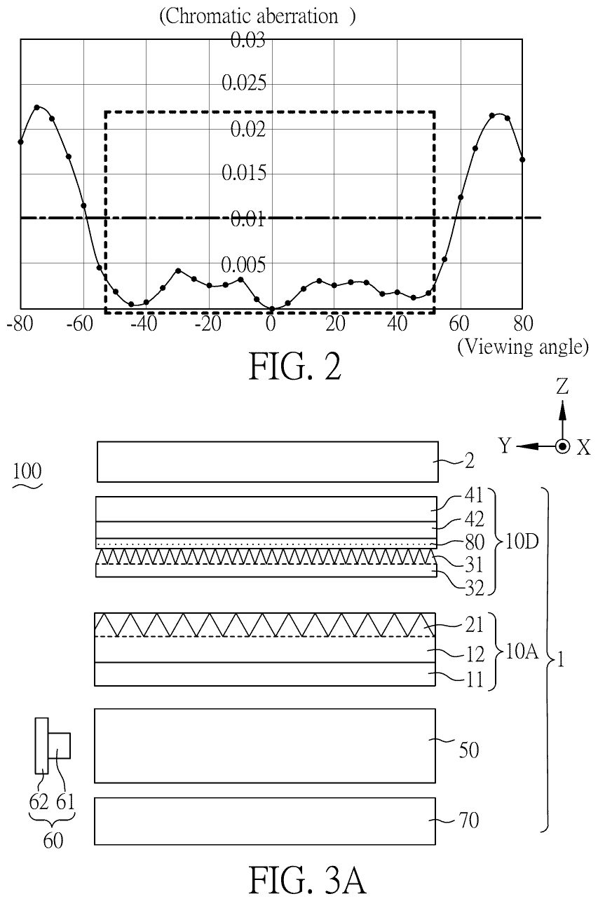

FIG. 2 is a schematic diagram of the viewing angle and chromatic aberration value of the electronic device 100 according to the first embodiment of the present disclosure, and please refer to FIG. 1A to FIG. 1D as a reference. The horizontal axis of FIG. 2 represents the viewing angle of the electronic device 100 in the horizontal direction, where 0 degrees corresponds to the front viewing angle, and the larger the angle, the larger the side viewing angle. The vertical axis represents the chromatic aberration value, such as the degree of chromatic aberration, and usually a chromatic aberration value of 0.01 is used as the standard value. For example, the chromatic aberration value should not be greater than 0.01. As shown in FIG. 2, when the light source providing element 1 has the optical films 10A to 10C, in the common viewing angle range (for example, the horizontal viewing angle of the user facing the electronic device 100 is between −60 degrees and 60 degrees), the chromatic aberration value corresponding to each viewing angle is lower than 0.01, which is an acceptable value. It can be seen that the yellow sun problem of the prior art can thus be solved, while it is not limited thereto.

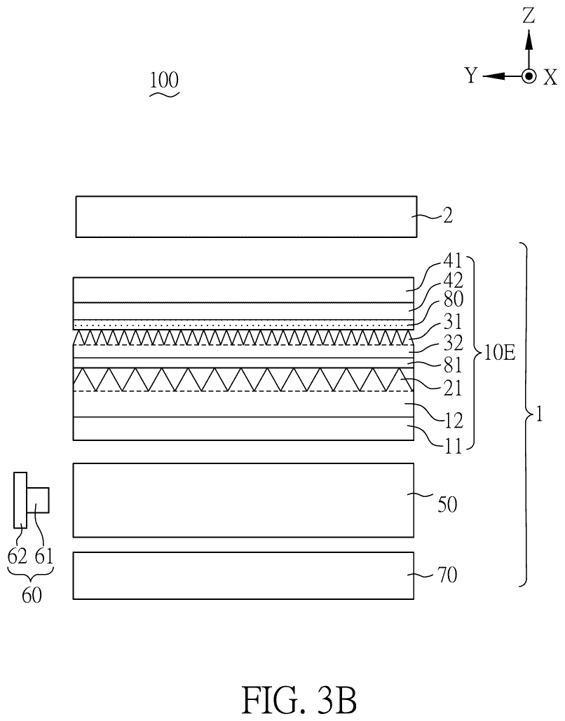

The first embodiment may have different variations. FIG. 3A is a schematic diagram of the electronic device according to the second embodiment of the present disclosure, and please refer to FIG. 1A to FIG. 2 as a reference. The features of FIG. 3A may generally be applicable to the description of FIG. 1A, and thus the following description mainly focuses on the differences.

As shown in FIG. 3A, the light source providing element 1 may also include an adhesive layer 80. In the Z direction, the adhesive layer 80 may be disposed between the third prism structure 31 and the fourth prism structure 41. For example, the third prism structure 31 may be disposed on the substrate 32, the adhesive layer 80 may be disposed on the third prism structure 31, the substrate 42 may be disposed on the adhesive layer 80, and the fourth prism structure 41 may be disposed on the substrate 42. In one embodiment, the material of the adhesive layer 80 may include, for example, optical clear adhesive (OCA), liquid optical clear adhesive (LOCA) or other materials with similar functions, but it is not limited thereto. In one embodiment, the adhesive layer 80 may be implemented as a full-surface adhesive or a patterned adhesive (such as a frame adhesive or other patterned adhesive), while it is not limited thereto. As a result, the third prism structure 31 and the fourth prism structure 41 may be fixed together through the adhesive layer 80; that is, the substrate 32, the third prism structure 31, the adhesive layer 80, the substrate 42 and the fourth prism structure 41 may form an optical film 10D. It can be seen from this that the light source providing element 1 in FIG. 3A may be equipped with two optical films 10A and 10D, and may provide similar effects to the first embodiment.

The first embodiment may also have different variations. FIG. 3B is a schematic diagram of the electronic device according to the third embodiment of the present disclosure, and please refer to FIG. 1A to FIG. 3A as a reference. The features of FIG. 3B are generally applicable to the description of FIG. 3A, and thus the following description mainly focuses on the differences.

As shown in FIG. 3B, the light source providing element 1 may also include another adhesive layer 81. The material or usage method of the other adhesive layer 81 may be applicable to the description of the adhesive layer 80 and thus a detailed description is deemed unnecessary. In the Z direction, the other adhesive layer 81 may be disposed between the second prism structure 21 and the third prism structure 31. For example, the substrate 12 may be disposed between the first prism structure 11 and the second prism structure 21, the other adhesive layer 81 may be disposed on the second prism structure 21, the substrate 32 may be disposed on the other adhesive layer 81, the third prism structure 31 may be disposed on the substrate 32, the adhesive layer 80 may be disposed on the third prism structure 31, the substrate 42 may be disposed on the adhesive layer 80, and the fourth prism structure 41 may be disposed on the substrate 42. Therefore, the first prism structure 11, the second prism structure 21, the third prism structure 31 and the fourth prism structure 41 may be fixed together by the adhesive layer 80 and the other adhesive layer 81; that is, the first prism structure 11, the substrate 12, the second prism structure 21, the other adhesive layer 81, the substrate 32, the third prism structure 31, the adhesive layer 80, the substrate 42 and the fourth prism structure 41 may form an optical film 10E. It can be seen from this that the light source providing element 1 in FIG. 3A may be equipped with an optical film 10E, and may provide effects similar to the first embodiment.

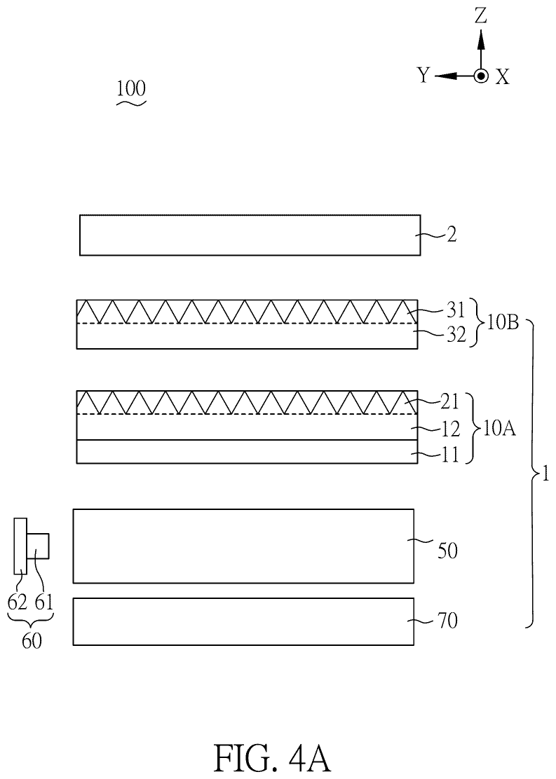

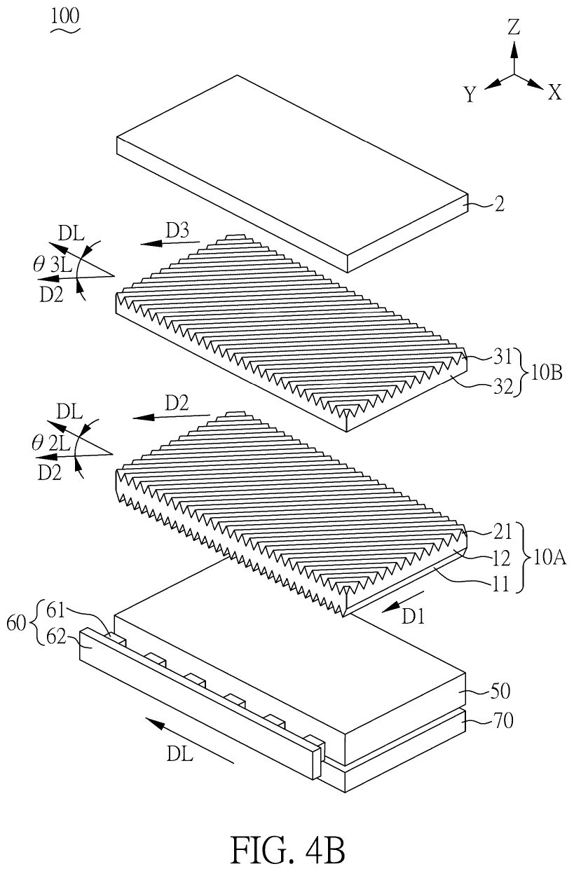

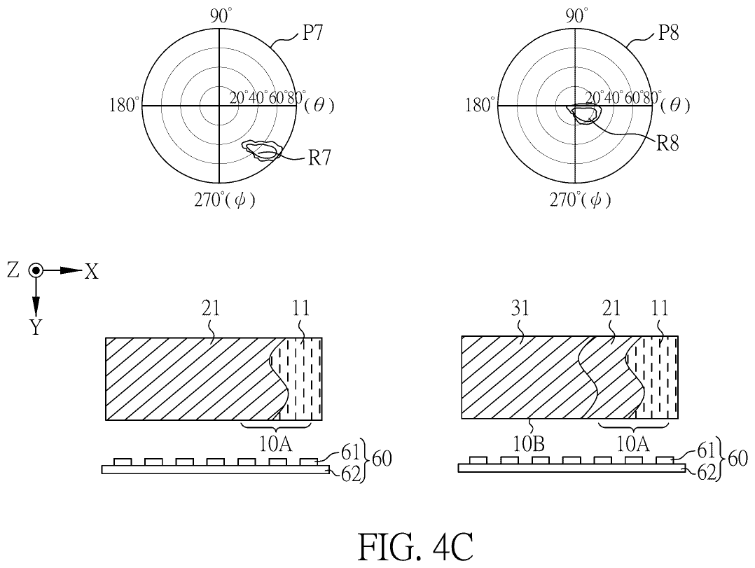

The optical film of the present disclosure may also be configured in different ways. Please refer to FIG. 4A and FIG. 4B. FIG. 4A is a schematic structural diagram of the electronic device 100 according to the fourth embodiment of the present disclosure that presents an exploded view from a single perspective, FIG. 4B shows a three-dimensional exploded view of the electronic device 100 according to the fourth embodiment of the present disclosure, and please refer to FIG. 1A to FIG. 3B as a reference. Some features of FIG. 4A and FIG. 4B are applicable to the description of FIG. 1A and FIG. 1B (first embodiment), and thus the following description mainly focuses on the differences.

As shown in FIG. 4A and FIG. 4B, the electronic device 100 may include a light source providing element 1 and a light adjustment element 2. The light source providing element 1 may include a first prism structure 11, a second prism structure 21, a third prism structure 31, a light guide plate 5, a light source 60 and a reflective sheet 70. The light source 60 has a light source extension direction DL, the first prism structure 11 has a first extension direction D1, the second prism structure 21 has a second extension direction D2, and the third prism structure 31 has a third extension direction D3. The first extension direction D1 is perpendicular to the light source extension direction DL. The included angle θ2L between the second extension direction D2 and the light source extension direction is 45 degrees or 135 degrees. In addition, different from the first embodiment, the included angle θ3L between the third extension direction D3 and the light source extension direction DL in the fourth embodiment is 45 degrees or 135 degrees.

In addition, the light source providing element 1 may include a substrate 12. In the Z direction, the first prism structure 11 and the second prism structure 21 may be respectively disposed on opposite sides of the substrate 12, whereby the first prism structure 11, the substrate 12 and the second prism structure 21 may form an optical film 10A. In addition, in one embodiment, the light source providing element 1 may include a substrate 32. In the Z direction, the third prism structure 31 may be disposed on one side of the substrate 32, such as the side away from the second prism structure 21, whereby the third prism structure 31 and the substrate 32 may form an optical film 10B.

The light source providing element 1 of the fourth embodiment may also improve the light extraction efficiency. FIG. 4C shows the light pattern diagrams P7 to P8 corresponding to the optical films 10A to 10B of the light source providing element 1 according to the fourth embodiment of the present disclosure, and please refer to FIG. 1A to FIG. 4B as a reference. The features of FIG. 4C may generally be applicable to the description of FIG. 1C, and thus the following description mainly focuses on the differences. The included angle θ2L between the second extension direction D2 of the second prism structure 21 and the light source extension direction DL may be 45 degrees or 135 degrees, and the included angle θ3L between the third extension direction D3 of the third prism structure 31 and the light source extension direction DL may be 45 degrees or 135 degrees, for example. For convenience of explanation, in FIG. 4C, the included angle θ2L of 45 degrees and the included angle θ3L of 45 degrees are taken as an example.

As shown in FIG. 4C, in one embodiment, when the light source providing element 1 only has an optical film 10A, the optical film 10A may unilaterally split the light passing through the light guide plate 50. For example, in the corresponding light pattern diagram P7, the light packets are roughly distributed in the area R7 with an azimuth angle of 270 degrees to 0 degrees and an inclination angle far away from 0 degrees (for example, 40 degrees to 80 degrees). Next, when the light source providing element 1 is equipped with the optical films 10A and 10B, on the corresponding light pattern diagram P8, the light packets are approximately disposed at or close to the center of the light pattern diagram P8 and the area R8 around the center. It can be seen that the light packets may be distributed at positions corresponding to the front viewing angle. Therefore, the light extraction efficiency of the electronic device 100 may be improved. It should be noted that the fourth embodiment may have effects similar to the first embodiment.

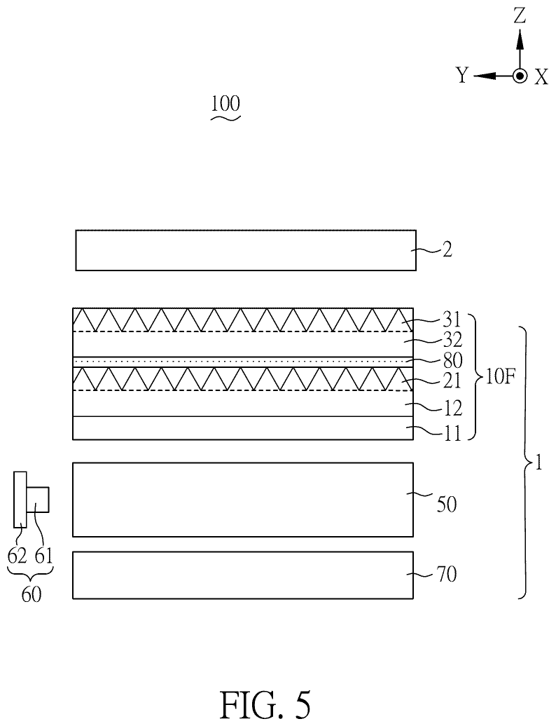

The fourth embodiment may also have different variations. FIG. 5 is a schematic diagram of the electronic device according to the fifth embodiment of the present disclosure, and please refer to FIG. 1A to FIG. 4C as a reference. The features of FIG. 5 may generally be applicable to the description of FIG. 4, and thus the following description mainly focuses on the differences.

As shown in FIG. 5, the light source providing element 1 may further include an adhesive layer 80 disposed between the second prism structure 21 and the third prism structure 31. For example, the substrate 12 may be disposed between the first prism structure 11 and the second prism structure 21, the adhesive layer 80 may be disposed on the second prism structure 21, the substrate 32 may be disposed on the adhesive layer 80, and the third prism structure 31 may be disposed on the substrate 32. In this way, the first prism structure 11, the second prism structure 21 and the third prism structure 31 may be fixed together by the adhesive layer 80; that is, the first prism structure 11, the substrate 12, the second prism structure 21, the adhesive layer 80, the substrate 32 and the third prism structure 31 may form an optical film 10F. Therefore, the light source providing element 1 in FIG. 5 may have an optical film 10F and may provide effects similar to the first embodiment.

In one embodiment, by means of bonding technology, the thickness of the light source providing element 1 in the Z direction of the various embodiments of the present disclosure may be reduced, so as to provide a thinning effect.

In one embodiment, the light extraction efficiency of the electronic device 100 in various embodiments of the present disclosure is substantially between 180% and 190%. Therefore, the electronic device 100 of the present disclosure may provide good light extraction efficiency, but it is not limited thereto.

Accordingly, the features of the electronic device 100 of the present disclosure can be understood.

It can be seen that the electronic device 100 of the present disclosure is equipped with a specially designed light source providing element 1, which may improve light extraction efficiency, reduce production costs, or solve the problem of yellow sun.

In one embodiment, the present disclosure may determine whether a product in contention falls within the protection scope of the present disclosure at least by the presence or absence of components, component configurations and/or physical appearance observation of the product, while it is not limited thereto. Furthermore, the physical appearance observation may be achieved by using an optical microscope or a scanning microscope, but not limited thereto.

The features of the various embodiments of the present disclosure may be mixed and matched as desired as long as they do not violate the spirit of the invention or conflict with each other.

The aforementioned specific embodiments should be construed as merely illustrative, and not limiting the rest of the present disclosure in any way.

1. An electronic device, comprising:
a light adjustment element; and
a light source providing element disposed below the light adjustment element, and including:
a light guide plate;
a light source adjacent to the light guide plate;
a first prism structure disposed on the light guide plate and facing the light guide plate;
a second prism structure disposed on the first prism structure and facing the light adjustment element; and
a third prism structure disposed on the second prism structure and facing the light adjustment element,
wherein an extension direction of the first prism structure is perpendicular to an extension direction of the light source, an included angle between an extension direction of the second prism structure and the extension direction of the light source is 45 degrees or 135 degrees, and an extension direction of the third prism structure is not perpendicular to the extension direction of the second prism structure.

2. The electronic device as claimed in claim 1, further comprising a fourth prism structure disposed on the third prism structure and facing the light adjustment element, wherein the extension direction of the third prism structure is parallel or perpendicular to the extension direction of the light source, and an extension direction of the fourth prism structure is perpendicular to the extension direction of the third prism structure.

3. The electronic device as claimed in claim 1, wherein an included angle between the extension direction of the third prism structure and the extension direction of the light source is 45 degrees or 135 degrees.

4. The electronic device as claimed in claim 1, further comprising a substrate, wherein the first prism structure and the second prism structure are respectively disposed on two sides of the substrate to form an optical film.

5. The electronic device as claimed in claim 1, further comprising a fourth prism structure disposed on the third prism structure and facing the light adjustment element, wherein an extension direction of the fourth prism structure is perpendicular to the extension direction of the third prism structure.

6. The electronic device as claimed in claim 5, wherein an included angle between the extension direction of the third prism structure and the extension direction of the light source is between 0 and 45 degrees.

7. The electronic device as claimed in claim 5, wherein a vertex angle of the first prism structure, a vertex angle of the second prism structure, a vertex angle of the third prism structure, or a vertex angle of the fourth prism structure is between 60 and 120 degrees.

8. The electronic device as claimed in claim 5, wherein an adhesive layer is provided between the fourth prism structure and the third prism structure.

9. The electronic device of claim 1, wherein a vertex angle of the first prism structure, a vertex angle of the second prism structure, or a vertex angle of the third prism structure is between 60 degrees and 120 degrees.

10. The electronic device as claimed in claim 1, wherein a refractive index of the first prism structure is between 1.5 and 1.55.

11. The electronic device as claimed in claim 1, wherein the light source providing element further includes a reflective sheet, and the light guide plate is disposed on the reflective sheet.

12. The electronic device as claimed in claim 1, wherein the first prism structure includes a plurality of first strip structures, each first strip structure extending along the extension direction of the first prism structure, the second prism structure includes a plurality of second strip structures, each second strip structure extending along the extension direction of the second prism structure, and the third prism structure includes a plurality of third strip structures, each third strip structure extending along the extension direction of the third prism structure.

13. The electronic device as claimed in claim 2, wherein the fourth prism structure includes a plurality of fourth strip structures, each fourth strip structure extending along the extension direction of the fourth prism structure.

14. The electronic device as claimed in claim 4, wherein the substrate has a first side and a second side opposite to each other, the second side of the substrate is adjacent to the light guide plate, the first prism structure is disposed on the second side of the substrate, and the second prism structure is disposed on the first side of the substrate.

15. The electronic device as claimed in claim 14, further comprising a further substrate having a first side and a second side opposite to each other, wherein the second side of the further substrate is adjacent to the second prism structure, and the third prism structure is disposed on the first side of the further substrate.

16. The electronic device as claimed in claim 15, further comprising a still further substrate having a first side and a second side opposite to each other, the first side of the still further substrate is far away from the light adjustment element, and the fourth prism structure is disposed on the first side of the still further substrate.

17. The electronic device as claimed in claim 10, wherein a refractive index of the second prism structure is between 1.5 and 1.55.

18. The electronic device as claimed in claim 17, wherein a refractive index of the third prism structure is between 1.5 and 1.69.

19. The electronic device as claimed in claim 18, wherein the refractive index of the fourth prism structure 41 is between 1.5 and 1.69.

20. The electronic device as claimed in claim 8, wherein a further adhesive layer is provided between the second prism structure and the third prism structure.
